(19) United States
(12) Patent Application Publication
(10) Pub. No.: US 2022/0405866 A1
(43) Pub. Date: Dec. 22, 2022

(54) INFORMATION PROCESSING METHOD, INFORMATION PROCESSING APPARATUS, AND RECORDING MEDIUM

(71) Applicant: CANON KABUSHIKI KAISHA, Tokyo (JP)

(72) Inventors: Junji Watanabe, Shizuoka (JP); Kazunari Kurokawa, Kanagawa (JP); Hideki Watanabe, Kanagawa (JP); Yuichi Matsumi, Kanagawa (JP); Kosuke Saito, Tokyo (JP); Naoki Sakai, Ibaraki (JP)

(21) Appl. No.: 17/836,547

(22) Filed: Jun. 9, 2022

(30) Foreign Application Priority Data
Jun. 18, 2021 (JP) 2021-101666

(51) Int. Cl. G06Q 50/04; G06Q 10/06

(52) U.S. Cl. CPC G06Q 50/04; G06Q 10/0633

(57) ABSTRACT

An information processing method includes preparing first data containing information of a workpiece, information of a product, and information of a plurality of tools used for machining the workpiece to manufacture the product. The information processing method includes instructing a job to generate second data by using the first data. The second data contains information of respective paths for the plurality of tools. The information processing method includes displaying a status of information processing of the job on a display portion after the instructing of the job. The displaying includes displaying, on the display portion, a status of first information processing of calculating a machined shape formed by a first tool included in the plurality of tools and a status of second information processing of calculating a path for the first tool that is performed after the first information processing.

### BACKGROUND OF THE INVENTION

### Field of the Invention

The present disclosure relates to information processing related to a path for a tool.

### Description of the Related Art

A machining support system that supports machining of a workpiece into a product by a numerical control machining apparatus: NC machining apparatus is known. Japanese Patent Laid-Open No. 2008-269501 discloses that a machining NC data generation tool application generates machining NC data on the basis of shape information of a workpiece and a product, and a machining procedure including a tool type designed by a machining procedure design tool application. In addition, Japanese Patent Laid-Open No. 2008-269501 discloses displaying, on a client terminal, an execution status of each computer-aided manufacturing application: CAM application for an initial input command.

Japanese Patent Laid-Open No. 2008-269501 discloses that processing of a machining NC data generation tool application takes a longer processing time than processing of other CAM application. In the case of using a plurality of tools to process a workpiece into a product, a longer time is required for generating machining NC data for all the plurality of tools. When a malfunction is found after the long time, the waiting time is wasted and the lead time is extended.

### SUMMARY OF THE INVENTION

According to a first aspect of the present invention, an information processing method includes preparing first data containing information of a workpiece, information of a product, and information of a plurality of tools used for machining the workpiece to manufacture the product. The information processing method includes instructing a job to generate second data by using the first data. The second data contains information of respective paths for the plurality of tools. The information processing method includes displaying a status of information processing of the job on a display portion after the instructing of the job. The displaying includes displaying, on the display portion, a status of first information processing of calculating a machined shape formed by a first tool included in the plurality of tools and a status of second information processing of calculating a path for the first tool that is performed after the first information processing.

According to a second aspect of the present invention, an information processing apparatus includes a processor. The processor is configured to execute processing to prepare first data containing information of a workpiece, information of a product, and information of a plurality of tools used for machining the workpiece to manufacture the product. The processor is configured to processing to instruct a job to generate second data by using the first data. The second data contains information of respective paths for the plurality of tools. The processor is configured to processing to display a status of information processing of the job on a display portion after the instructing of the job. The processing to display includes displaying, on the display portion, a status of first information processing of calculating a machined shape formed by a first tool included in the plurality of tools and a status of second information processing of calculating a path for the first tool that is performed after the first information processing.

According to a third aspect of the present invention, an information processing method includes obtaining first data containing information of a workpiece, information of a product, and information of a plurality of tools used for manufacturing the product by machining the workpiece. The information processing method includes generating second data by using the first data. The second data contains information of respective paths for the plurality of tools. The generating the second data includes performing first information processing of calculating a machined shape formed by a first tool included in the plurality of tools and second information processing of calculating a path for the first tool that is performed after the first information processing.

Further features of the present invention will become apparent from the following description of exemplary embodiments with reference to the attached drawings.

### BRIEF DESCRIPTION OF THE DRAWINGS

FIG. 1 is an explanatory diagram illustrating an example of a system including an information processing apparatus according to an embodiment.

FIG. 2 is a block diagram for describing a function of an information processing apparatus and a server according to the embodiment.

FIG. 3 is a flowchart illustrating an information processing method according to the embodiment.

FIG. 4 is a flowchart illustrating the information processing method according to the embodiment.

FIG. 5A is a schematic view of a three-dimensional model according to the embodiment.

FIG. 5B is an explanatory diagram of an example of an interface image according to the embodiment.

FIG. 6 is an explanatory diagram of an interface image according to an embodiment.

FIG. 7A is a Gantt chart indicating a schedule of tool path generation of a comparative example.

FIG. 7B is a Gantt chart indicating a schedule of tool path generation according to the embodiment.

FIG. 8 is an explanatory diagram of the tool path generation according to the embodiment.

FIG. 9A is an explanatory diagram of an inverse offset method according to the embodiment.

FIG. 9B is an explanatory diagram of the inverse offset method according to the embodiment.

FIG. 9C is an explanatory diagram of the inverse offset method according to the embodiment.

FIG. 10A is an explanatory diagram of an example of the interface image according to the embodiment.

FIG. 10B is an explanatory diagram of an example of the interface image according to the embodiment.

FIG. 10C is an explanatory diagram of an example of the interface image according to the embodiment.

FIG. 10D is an explanatory diagram of an example of the interface image according to the embodiment.

FIG. 11A is an explanatory diagram of an example of the interface image according to the embodiment.

FIG. 11B is an explanatory diagram of an example of the interface image according to the embodiment.

FIG. 11C is an explanatory diagram of an example of the interface image according to the embodiment.

FIG. 12A is an explanatory diagram of an example of the interface image according to the embodiment.

FIG. 12B is an explanatory diagram of an example of the interface image according to the embodiment.

FIG. 13A is a schematic diagram illustrating an example of results of simulation of electric discharge machining according to the embodiment.

FIG. 13B is a schematic diagram illustrating an example of results of simulation of electric discharge machining according to the embodiment.

### DESCRIPTION OF THE EMBODIMENTS

An embodiment of the present invention will be described in detail below with reference to drawings.

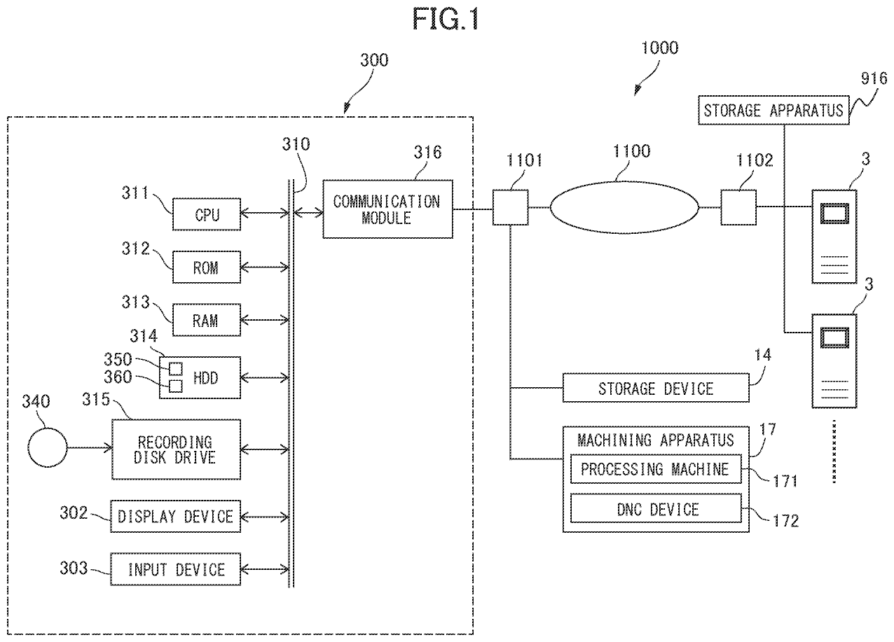

FIG. 1 is an explanatory diagram illustrating an example of a system 1000 including an information processing apparatus 300 according to the embodiment. The system 1000 is a client-server system. The information processing apparatus 300 includes at least a processor. The information processing apparatus 300 is a client personal computer: client PC constituted by a computer. The information processing apparatus 300 is connected to a plurality of servers 3 via a router 1101, a network 1100, and a router 1102 such that data can be communicated therebetween. To be noted, a storage apparatus 916 is connected to the plurality of servers 3. The servers 3 are each a calculation server constituted by a computer, and the storage apparatus 916 is a data server.

The information processing apparatus 300 includes a display device 302 serving as an example of a display portion, and an input device 303 serving as an example of an input portion. Examples of the display device 302 include a graphic board included in the information processing apparatus 300, a display device connected to the graphic board, and the like, and is capable of displaying an interface image serving as a user interface. The display device 302 may have a single display configuration or a multi display configuration. The input device 303 is constituted by, for example, a keyboard, a mouse, and the like, and receives input from a user. The user is capable of inputting input information to the information processing apparatus 300 by operating the input device 303. To be noted, the display portion and the input portion may be constituted by a touch panel on which a user can perform input operation by touch on a screen.

In addition, the information processing apparatus 300 includes a central processing unit: CPU 311 serving as a processor capable of performing information processing. In addition, the information processing apparatus 300 includes a read-only memory: ROM 312, a random access memory: RAM 313, and a hard disk drive: HDD 314 as storage portions. In addition, the information processing apparatus 300 includes a recording disk drive 315 and a communication module 316. The CPU 311, the ROM 312, the RAM 313, the HDD 314, the recording disk drive 315, the communication module 316, the display device 302, and the input device 303 are interconnected via a bus 310.

The ROM 312 is a non-transitory storage device. The ROM 312 stores a basic program that is loaded by the CPU 311 when booting the computer. The RAM 313 is a transitory storage device used for arithmetic processing by the CPU 311. The HDD 314 is an example of an internal storage, and is a non-transitory storage device that stores various data such as results of the arithmetic processing by the CPU 311. In the present embodiment, the HDD 314 stores a program 350, and computer-aided design software: CAD software 360. That is, the program 350 and the CAD software 360 are installed in the information processing apparatus 300. The program 350 is application software. The CPU 311 executes processing that will be described later by executing the program 350. In addition, the CPU 311 can, by executing the CAD software 360, generate CAD data on the basis of input information from a user, and display an image corresponding to the CAD data on the display device 302. The information processing apparatus 300 is a computer in which the program 350 can be executed by a processor, that is, the CPU 311. The display device 302, the input device 303, the communication module 316, and so forth do not need to be included in the information processing apparatus 300, and may be separately provided from the information processing apparatus 300 and externally attached thereto.

The recording disk drive 315 is capable of reading various data, programs, and the like recorded in a recording disk 340. The communication module 316 is, for example, a local area network: LAN module, and is capable of communicating with the servers 3 by communicating with the router 1101 via wired communication or wireless communication.

To be noted, in the present embodiment, the HDD 314 is a non-transitory recording medium that can be read by a processor of a computer, and stores the program 350. However, the configuration is not limited to this. The program 350 may be recorded in any recording medium as long as the recording medium is a non-transitory recording medium that can be read by a processor of a computer. Examples of the recording medium for supplying the program 350 to the computer include flexible disks, optical disks, magneto-photo disks, magnetic tapes, and non-volatile memories.

The router 1101 is connected to the storage device 14 and a machining apparatus 17. As a result of this, the information processing apparatus 300 is capable of communicating data with the storage device 14 and the machining apparatus 17. The machining apparatus 17 includes a processing machine 171 and a direct numerical control: DNC device 172. A plurality of tools are attached to the processing machine 171. The DNC device 172 controls the processing machine 171 on the basis of NC data, and thus the processing machine 171 processes a workpiece to manufacture a product.

In the present embodiment, an example of manufacturing, by the machining apparatus 17, an electrode that is used for manufacturing a mold by electric discharge machining of a metal workpiece will be described. That is, in the present embodiment, a case where the product that is manufactured by processing a workpiece by the processing machine 171 is an electrode will be described as an example. A plurality of electrodes are required for manufacturing a mold.

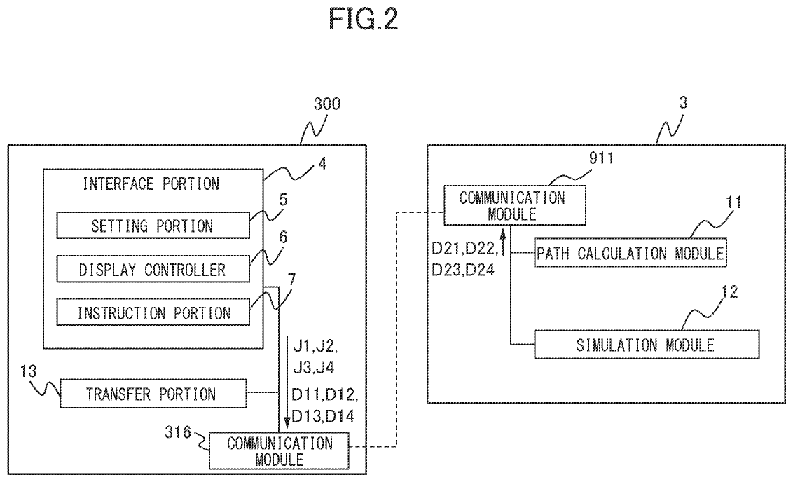

FIG. 2 is a block diagram for describing functions of the information processing apparatus 300 and the server 3 according to the embodiment. FIG. 2 illustrates only one of the plurality of servers 3 for the sake of convenience of description. The CPU 311 of FIG. 1 executes the program 350, and thus functions as an interface portion 4 and a transfer portion 13 of FIG. 2. The interface portion 4 includes functions as a setting portion 5, a display controller 6, and an instruction portion 7. The server 3 includes a communication module 911, a path calculation module 11, and a simulation module 12. That is, a program that functions as the path calculation module 11 and a program that functions as the simulation module 12 are installed in each of the plurality of servers 3.

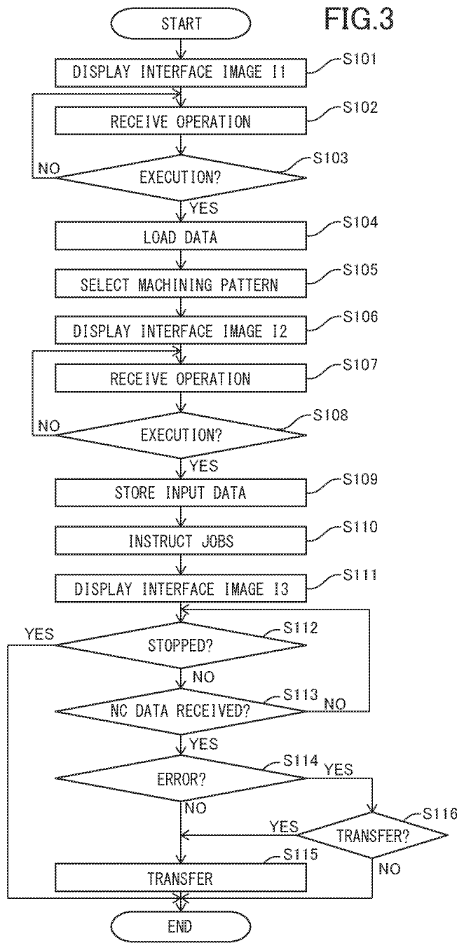

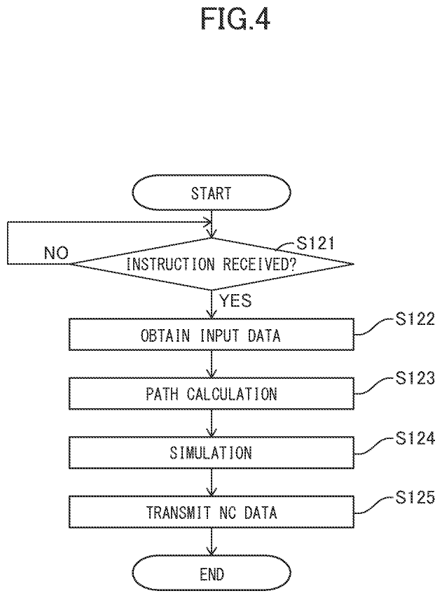

FIGS. 3 and 4 are each a flowchart illustrating an information processing method according to the embodiment. FIG. 3 illustrates a flowchart indicating a processing procedure of the information processing apparatus 300, and FIG. 4 illustrates a flowchart indicating a processing procedure of the server 3. A case where a plurality of products that are to be manufactured by the machining apparatus 17 are four electrodes will be described below as an example. By executing the program 350, the CPU 311 of the information processing apparatus 300 functions as the setting portion 5, the display controller 6, the instruction portion 7, and the transfer portion 13, and executes each step of the information processing method illustrated in FIG. 3.

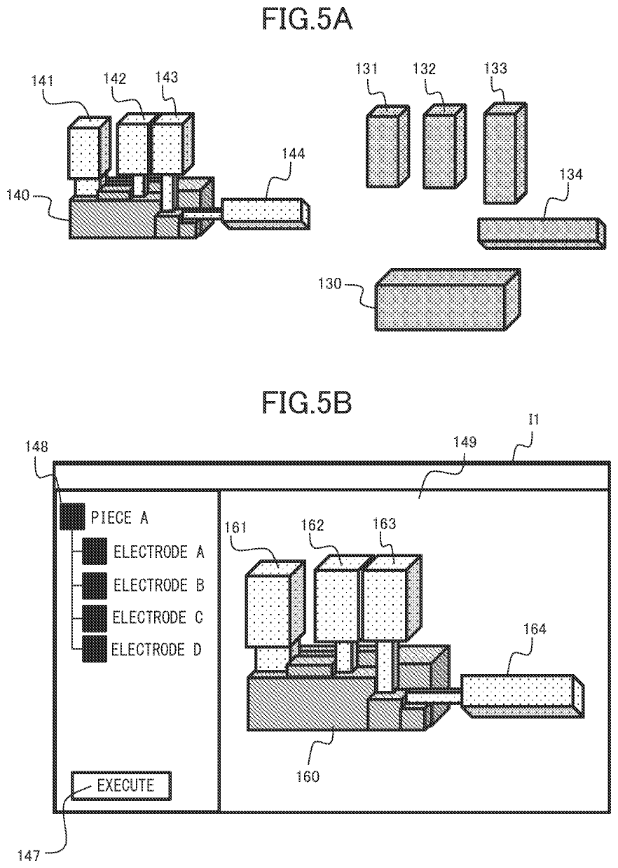

FIG. 5A is a schematic view of a three-dimensional model according to the embodiment. FIG. 5A illustrates a piece model 140 corresponding to a piece constituting a mold, and four electrode models 141 to 144 corresponding to four electrodes that are used for forming the piece by electric discharge machining. The models 140 to 144 are respectively associated with workpiece models 130 to 134 corresponding to the workpiece. The models 130 to 134 and 140 to 144 contain three-dimensional models of CAD data (shape data) generated by the CAD software 360 and information of materials.

FIG. 5B is an explanatory diagram of an example of an interface image I1 according to the embodiment. here, for example, the workpiece model 131 is a model of a first workpiece, and the workpiece model 132 is a model of a second workpiece. In addition, the electrode model 141 is a model of a first electrode serving as a first product, and the electrode model 142 is a model of a second electrode serving as a second product.

First, in step S101, the display controller 6 displays the interface image I1 serving as a user interface on the display device 302.

The interface image I1 contains an execution button 147 that can be operated by the user, a tree display area 148 that can be operated by the user, and a model display area 149 that can be operated by the user. The interface image I1 is displayed on the display device 302 as one window. To be noted, the display controller 6 may use the function of the CAD software 360 to display the interface image I1.

The display controller 6 displays a tree of “Piece A” corresponding to the piece, and “Electrode A”, “Electrode B”, “Electrode C”, and “Electrode D” corresponding to the four electrodes in the tree display area 148. The “Piece A” is a parent node. “Piece A” is assigned with four child nodes “Electrode A”, “Electrode B”, “Electrode C”, and “Electrode D”. In addition, the display controller 6 displays images 160 to 164 corresponding to the models 140 to 144 in the model display area 149.

“Electrode A” to “Electrode D” are respectively associated with the electrode models 141 to 144. In the display area, “Electrode A” means the electrode model 141, “Electrode B” means the electrode model 142, “Electrode C” means the electrode model 143, and “Electrode D” means the electrode model 144. Images 161 to 164 in the model display area 149 are respectively associated with the electrode models 141 to 144.

In step S102, the setting portion 5 receives an operation from a user on the interface image I1. When, for example, “Electrode A” is operated by the user in the tree display area 148, the setting portion 5 sets the corresponding electrode model 141 as a loading candidate. In addition, when, for example, “Piece A” is operated by the user in the tree display area 148, the setting portion 5 sets the four electrode models 141 to 144 as loading candidates. In addition, when, for example, the image 161 is operated by the user in the model display area 149, the setting portion 5 sets the corresponding electrode model 141 as a loading candidate. In addition, when, for example, the image 160 is operated by the user in the model display area 149, the setting portion 5 sets the four electrode models 141 to 144 as loading candidates. As described above, the user can select the electrode to be manufactured while looking at the interface image I1, and thus the operation efficiency of the user is improved. In addition, since all the electrode models 141 to 144 are selected by just the user selecting “Piece A” or the image 160 corresponding to the piece model 140, the operation efficiency of the user is improved.

In the case where the execution button 147 is not operated by the user, that is, in the case where the result of step S103 is NO, the setting portion 5 maintains a standby state for the selection of a loading candidate. In the case where the execution button 147 is operated by the user, that is, in the case where the result of step S103 is YES, the setting portion 5 loads data containing the electrode model set as the loading candidate and the workpiece model corresponding to the electrode model from the CAD software 360 in step S104. The loaded electrode model serves as information of the electrode, that is, information of the product. In addition, the loaded workpiece model serves as information of the workpiece.

To be noted, although it has been mentioned that the setting portion 5 loads these data from the CAD software 360, the configuration is not limited to this. For example, the setting portion 5 may load these data from an internal storage or an external storage, or from an external device via a network. In addition, although the setting portion 5 starts the data loading operation in the case where the execution button 147 is operated, the configuration is not limited to this. For example, each time a certain portion of the tree display area 148 or the model display area 149 is operated by the user, loading operation of the corresponding data may be started.

A case where the setting portion 5 loads the four electrode models 141 to 144 and the four workpiece models 131 to 134 corresponding to these will be described below as an example. In step S105, on the basis of the respective loaded electrode models 141 to 144, the setting portion 5 automatically selects respective machining patterns corresponding to the electrode models 141 to 144 by referring to preset data. The data the setting portion 5 refers to in this step S105 is data generated in advance by an operator by performing machining tests and adjusting the types of tools, movement speed, rotation speed, machining types, and the like of the tools, and the like.

The machining pattern contains information of a plurality of tools used for manufacturing the corresponding electrode by machining the corresponding workpiece, information of machining type of each tool, and information of machining condition of each tool. The information of a tool is information of a tool set in the processing machine 171, and contains the type of the tool such as a drill or an endmill, the diameter of the tool, and the length of the tool. The information of the machining type is information indicating the type of the tool path for rough contour machining, finishing contour machining, surface machining, or the like. The information of the machining condition is information containing the movement speed and rotation speed of the tool.

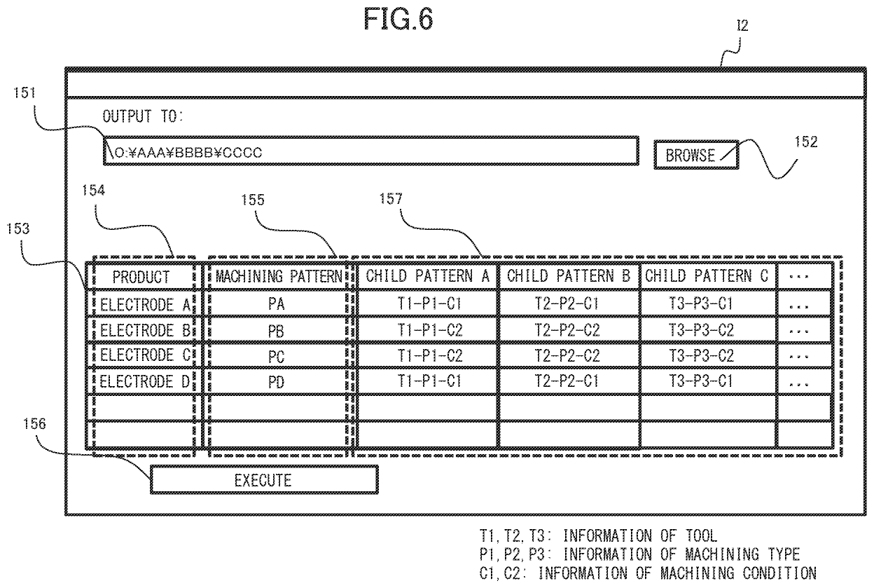

FIG. 6 is an explanatory diagram of an example of an interface image 12 according to the embodiment. In step S106, the display controller 6 displays the interface image 12 serving as a user interface. The interface image 12 contains a text box 151, a browse button 152, a table 153, and an execution button 156. The interface image 12 is displayed as a single window on the display device 302.

In FIG. 6, in the table 153, names of electrodes serving as products to be manufactured, for example, electrode A, electrode B, electrode C, and electrode D, and selection results of machining patterns PA to PD corresponding to respective electrodes are displayed as a list. The table 153 contains a plurality of items 154, 155, and 157. In the item 154, the product name is displayed. In the item 155, the machining pattern name is displayed. In the item 157, child pattern names of a plurality of child patterns constituting the machining pattern are displayed.

The electrodes A to D respectively correspond to the machining patterns PA to PD. The machining patterns PA to PD each contain information of a plurality of tools. For example, a case where the machining pattern PA corresponding to the electrode A contains information of four tools will be described. The machining patterns PA to PD each contain a plurality of child patterns A, B, C . . . . The child patterns A, B, C . . . each contain information of one tool, information of a machining type of the corresponding tool, and information of a machining condition of the corresponding tool. Therefore, as a result of containing a plurality of child patterns, the machining patterns PA to PD each contain information of a plurality of tools, information of machining type of each of the plurality of tools, and information of machining condition of each of the plurality of tools.

The information of respective tools is respectively associated with displayed names T1, T2, T3 . . . . That is, the names T1, T2, T3 . . . are information about respective tools. The information of respective machining types is associated with displayed names P1, P2, P3 . . . . That is, the names P1, P2, P3 . . . are information about respective machining types. The information of respective machining conditions is associated with displayed names C1, C2 . . . . That is, the names C1, C2 . . . are information about respective machining conditions. As a result of this, the user can recognize the information about the plurality of tools, the information about the machining types, and the information about the machining conditions for each of the electrodes A to D by looking at the names displayed in the table 153.

The plurality of tools used for manufacturing each of the electrodes A to D are used in the order of the child patterns A, B, C . . . . That is, the order of the child patterns A, B, C . . . is information indicating the use order of the plurality of tools. Alternatively, an external file describing the use order of tools determined in advance for a set of names such as T1, T2, T3 . . . , P1, P2, P3 . . . , or C1, C2 . . . , and the use order of the tools may be determined in accordance with the names described in the external file and the names that are displayed.

In step S107, the setting portion 5 receives an operation from a user on the interface image 12. In the table 153, the information (data) of the child patterns A, B, C . . . of each of the machining patterns PA to PD can be changed by the user changing the names in the table 153. The change may be made by selection by the user from a displayed list, or by text input by the user. When the name of a child pattern is changed by the user in the table 153, the setting portion 5 changes the information of the child pattern to information corresponding to the name to which the name has been changed. For example, in the case where, for the child pattern B corresponding to the electrode A, the name P2 is changed to the name P3 by the user, the setting portion 5 changes the information of the machining type to that corresponding to the name P3 in the machining pattern PA. To be noted, in the table 153, the user can manually select a new electrode and a new machining pattern corresponding to the new electrode. By displaying the table 153 in the interface image 12, a different interface image does not need to be opened for each product, and it becomes easier for the operator to view, change, or newly generate machining patterns.

The text box 151 is a box for designating a folder where input data containing these machining patterns. The browse button 152 is a button for displaying a tree of folders. In the case where the execution button 156 is not operated by the user, that is, in the case where the result of step S108 is NO, the setting portion 5 maintains the standby state for change of newly generation of the table 153.

In the case where the execution button 156 is operated by the user, that is, in the case where the result of step S108 is YES, in step S109, the setting portion 5 stores data containing the electrode model, the workpiece model, and the machining pattern in the folder designated in the interface image 12 as input data. As a result of the processing of steps S101 to S109 described above, input data is prepared. To be noted, the folder is, for example, a folder in the HDD 314.

That is, the setting portion 5 prepares, as input data D11, first data containing the workpiece model 131, the electrode model 141, and the machining pattern PA. The setting portion 5 prepares, as input data D12, third data containing the workpiece model 132, the electrode model 142, and the machining pattern PB. The setting portion 5 prepares, as input data D13, fifth data containing the workpiece model 133, the electrode model 143, and the machining pattern PC. The setting portion 5 prepares, as input data D14, seventh data containing the workpiece model 134, the electrode model 144, and the machining pattern PD.

Next, in step S110, the instruction portion 7 transmits a plurality of jobs J1 to J4 corresponding to the plurality of pieces of input data D11 to D14 to the servers 3 together with the plurality of pieces of input data D11 to D14, and thus instructs the servers 3 to perform the plurality of jobs J1 to J4.

The job J1 serves as a first job, the job J2 serves as a second job, the job J3 serves as a third job, and the job J4 serves as a fourth job. The job J1 is a job for generating NC data D21 serving as second data by using the input data D11, and corresponds to the electrode A. The job J2 is a job for generating NC data D22 serving as fourth data by using the input data D12, and corresponds to the electrode B. The job J3 is a job for generating NC data D23 serving as sixth data by using the input data D13, and corresponds to the electrode C. The job J4 is a job for generating NC data D24 serving as eighth data by using the input data D14, and corresponds to the electrode D.

These input data D11 to D14 and jobs J1 to J4 are collectively transmitted to the servers 3 via the network 1100 by one operation from the user such as the user operating the execution button 156. As a result of this, the user does not need to open an interface image individually for each of the plurality of electrodes, can send an instruction of the plurality of jobs J1 to J4 to the server 3 at once, and therefore, the operation efficiency of the user is improved. In addition, the servers 3 can continuously calculate paths for tools, and thus the operation efficiency of the servers 3 is improved. As a result, the lead time is shortened.

The NC data D21 to D24 generated in the server 3 each contain information (data) of path for each of the plurality of tools corresponding thereto. For example, the NC data D21 contains information (data) of path for each of four tools.

Processing by the servers 3 having received the jobs J1 to J4 will be described. The plurality of servers 3 perform distributed processing of the received jobs J1 to J4. The plurality of servers 3 process the jobs J1 to J4 in this order. The processing for each of the plurality of jobs J1 to J4 is substantially the same. Therefore, only the processing for the job J1 will be described, and detailed description of the processing for the jobs J2 to J4 will be omitted.

As illustrated in FIG. 4, in the case where an instruction from the information processing apparatus 300 is not received, that is, in the case where the result of step S121 is NO, the servers 3 are in a standby state for the instruction. In the case where an instruction from the information processing apparatus 300 is received, that is, in the case where the result of step S121 is YES, the servers 3 obtain input data in step S122, and executes the processing of path calculation in step S123. For example, in step S122, the servers 3 obtain the job J1 and the input data D11 corresponding to the job J1 from the information processing apparatus 300. Then, in step S123, the servers 3 generate the NC data D21 by using the input data D11 corresponding to the job J1. As described above, the servers 3 generate the NC data D21 corresponding to the job J1.

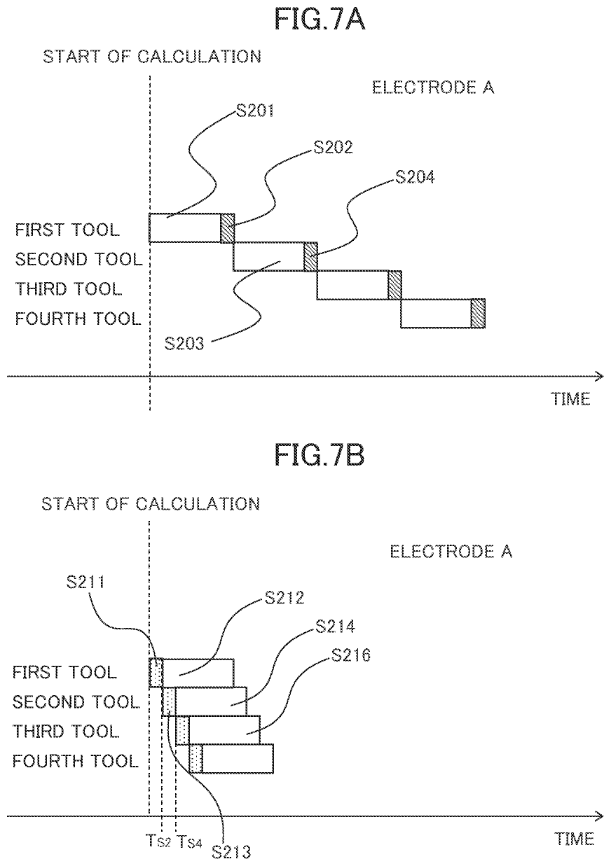

First, information processing of path calculation for a comparative example will be described in detail. FIG. 7A is a Gantt chart illustrating a schedule of tool path generation of the comparative example. In the case where a plurality of steps are required for manufacturing the electrode A, one tool is used in each step. In cutting, the region where the tool can process differs depending on the diameter of the tool, the length of the tool, and the rounding of the tool, and the shape of an uncut portion also differs. Here, the tools used for the path calculation are tool models based on information of the tools.

As illustrated in FIG. 7A, in the path calculation of the comparative example, in step S201, a path for a first tool corresponding to the workpiece shape is generated. Next, in step S202, cutting on the workpiece shape is simulated on the basis of the path for the first tool. As a result of this, the shape of an uncut portion is calculated from the workpiece shape. Next, in step S203, a path for a second tool corresponding to the uncut portion shape is generated. Next, in step S204, cutting on the uncut portion shape is simulated on the basis of the path for the second tool. As described above, the path calculation for the second tool in step S203 cannot be started until the uncut portion shape is calculated in step S202. Therefore, the tool path calculation and uncut portion shape calculation of all the steps are serial calculation, which takes time for processing. Particularly, processing of steps S201 and S203 takes time.

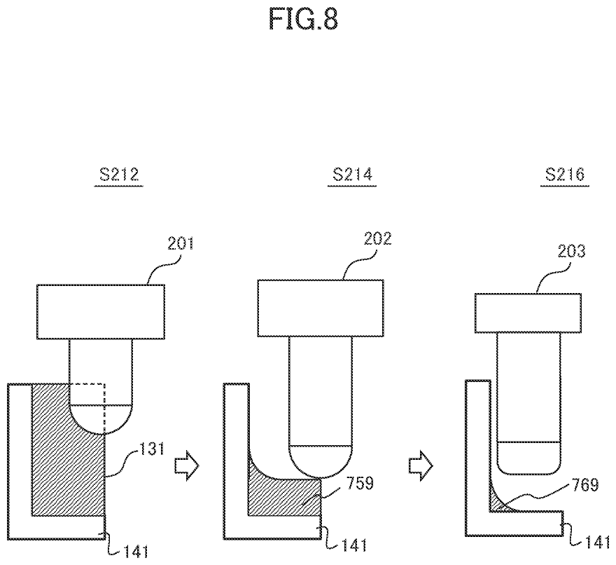

FIG. 7B is a Gantt chart illustrating a schedule of tool path generation according to the embodiment. FIG. 8 is an explanatory diagram of tool path generation according to the embodiment. FIG. 8 illustrates a first tool 201, a second tool 202, and a third tool 203 among the plurality of tools, that is, the four tool models. FIG. 8 illustrates the shape of the workpiece model 131, the shape of the electrode model 141, an uncut portion shape 759 that is a machined shape formed by the first tool 201, and an uncut portion shape 769 that is a machined shape formed by the second tool 202.

In the present embodiment, the path calculation module 11 of one of the plurality of servers 3 executes step S211 in which the cut shape formed by the first tool 201, that is, the uncut portion shape 759 is calculated. The tool 201 serves as a first tool, and step S211 can serve as first information processing. The uncut portion shape 759 calculated in step S211 is different from the uncut portion shape calculated in step S201 on the basis of the results of path calculation, and can be calculated by an inverse offset method that requires less computational load as disclosed in Japanese Patent Laid-Open No. 2001-242919. For the calculation of the uncut portion shape 759, information of the shape of the workpiece, that is, the workpiece model 131, the information of the tool 201, and the information of the shape of the final product, that is, the electrode model 141 can be used. The information of the uncut portion shape 759 calculated in step S211 can be used for step S214 for calculating the path for the second tool 202. Next, after step S211, the path calculation module 11 executes step S212 for calculating the path for the tool 201 on the basis of the workpiece model 131 indicating the workpiece shape. Step S212 can serve as second information processing. Step S212 corresponds to step S201 of FIG. 7A. To be noted, the information of the uncut portion shape 759 calculated in step S211 does not have to be used for step S212 for calculating the path for the first tool 201.

In the present embodiment, the path calculation module 11 of another one of the plurality of servers 3 executes step S214 in which the path for the second tool 202 is calculated on the basis of the uncut portion shape 579 obtained by the calculation of step S211. The second tool 202 is a tool that is used after the machining by the first tool 201. The second tool 202 serves as a second tool, and step S214 can serve as third information processing. Step S214 corresponds to step S203 of FIG. 7A. For step S214 for calculating the path for the second tool 202, the information of the shape of the workpiece at the start of machining by the second tool 202. The uncut portion shape 759 corresponds to the shape of the workpiece at the end of the machining by the first tool 201, and also to the shape of the workpiece at the start of the machining by the second tool 202. Therefore, if the uncut portion shape 759 is obtained in step S211, step S214 for calculating the path for the second tool 202 can be performed. As can be seen from FIG. 7B, steps S212 and S214 can be performed in parallel by the plurality of servers 3.

The path calculation module 11 executes step S213 for calculating the machined shape formed by the second tool 202, that is, the uncut portion shape 769 in a period between steps S211 and S214, that is, between an end timing T_{S2} of step S211 and a start timing T_{S4} of step S214. Step S213 can serve as fourth information processing. The uncut portion shape 769 calculated in step S213 can be also calculated by the inverse offset method whose computational load is small. For the calculation of the uncut portion shape 769, information of the shape of the workpiece, that is, the uncut portion shape 759 calculated in step S211, the information of the tool 201, and the information of the shape of the final product, that is, the electrode model 141 can be used. The information of the uncut portion shape 769 calculated in step S213 can be used for step S216 for calculating the path for the third tool 203. In step S216 for calculating the path for the third tool 203, the information of the shape of the workpiece at the start of machining by the third tool 203 is used. The uncut portion shape 769 corresponds to the shape of the workpiece at the end of the machining by the second tool 202, and also to the shape of the workpiece at the start of the machining by the third tool 203. Therefore, when the uncut portion shape 769 is obtained in step S212, step S216 for calculating the path for the third tool 203 can be performed. The uncut portion shape 769 calculated in step S213 does not have to be used for step S214 for calculating the path for the second tool 202. As can be seen from FIG. 7B, steps S212, S214, and S216 can be performed in parallel by the plurality of servers 3. To be noted, in the case of relatively simple machining such as 3-axis machining, the workpiece model 131 may be used in place of the uncut portion shape 759 in step S213 for calculating the uncut portion shape 769 formed by the second tool 202. In this case, the calculation of the uncut portion shape 769 formed by the second tool 202 in step S213 can be started before the calculation of the uncut portion shape 759 formed by the previous tool, that is, the first tool 201 in step S211, and, for example, steps S211 and S213 can be performed in parallel. In the case of relatively complex machining such as 4-axis machining or 5-axis machining, the calculation of the uncut portion shape 769 formed by the next tool, that is, the second tool 202 in step S213 can be performed by using the uncut portion shape 759 formed by the previous tool, that is, the first tool 201. That is, step S213 is performed after step S211.

As described above, according to the present embodiment, since the uncut portion shape 759 is calculated in step S211 by the inverse offset method, the path calculation for the tool 202 can be performed in step S214 by using the uncut portion shape 759 before the path calculation for the tool 201 is finished. Since parallel calculation can be performed as described above, the calculation can be performed efficiently, thus the calculation time can be shortened, and the lead time can be shortened. In addition, the uncut portion shape 769 can be obtained in next step S213 immediately after the uncut portion shape 759 is obtained in step S211. Therefore, step S213 can be executed in parallel with the detailed path calculation of step S212, thus the calculation time can be shortened, and the lead time can be shortened. The first tool and the second tool has been described above, and the same applies to the third tool and the fourth tool. To be noted, the calculation described as being performed in parallel by a plurality of processors (servers) may be performed by one processor sequentially or in parallel.

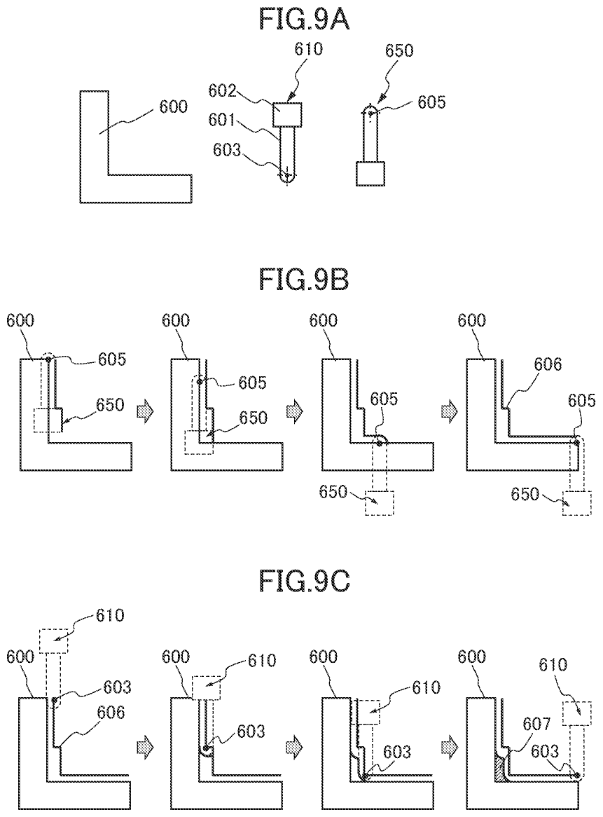

FIGS. 9A to 9C are explanatory diagrams for the inverse offset method according to the embodiment. As illustrated in FIG. 9A, a tool model 610 contains a body shape 601 and a holder shape 602. The path calculation module 11 generates an uncut portion shape by using a product model 600 and the tool model 610. First, the path calculation module 11 calculates an inverse tool model 650 corresponding to the tool model 610. Next, as illustrated in FIG. 9B, the path calculation module 11 moves the inverse tool model 650 in a scanning manner such that a center point 605 of the inverse tool model 650 always coincides with the surface of the product model 600, and obtains a trajectory 606 drawn by the outermost peripheral surface of the inverse tool model 650. Next, as illustrated in FIG. 9C, the path calculation module 11 moves the tool model 610 in a scanning manner such that a center point 603 of the tool model 610 always coincides with the trajectory 606. Then, the path calculation module 11 sets a region serving as a difference between the trajectory drawn by a tip end of the tool model 610 and the product model 600 as an uncut portion shape 607. The second and later uncut portion shapes can be obtained by applying the inverse offset method to the previous uncut portion shape such as the product model. In addition, for the second and later tools, a temporary uncut portion shape may be obtained by using the inverse offset method on the product model 600, and a portion where the uncut portion shape formed by the previous tool and the temporary uncut portion shape may be set as the uncut portion shape. To be noted, as described above, in the case of calculating the uncut portion shape formed by the second or later tool by using the workpiece model 131 instead of the uncut portion shape formed by a tool immediately prior to the tool of interest, it is preferable that the holder shape 602 is set to be the same for the tools. Although an example of calculation of the uncut portion shape has been described above, the method for calculating the uncut portion shape is not limited to the inverse offset method as long as the method does not use the tool path. In addition, the tool model 610 may be stored in advance in a database in the servers 3, or may be contained in the input data D11 to D14 as tool information and transmitted to the servers 3 from the information processing apparatus 300.

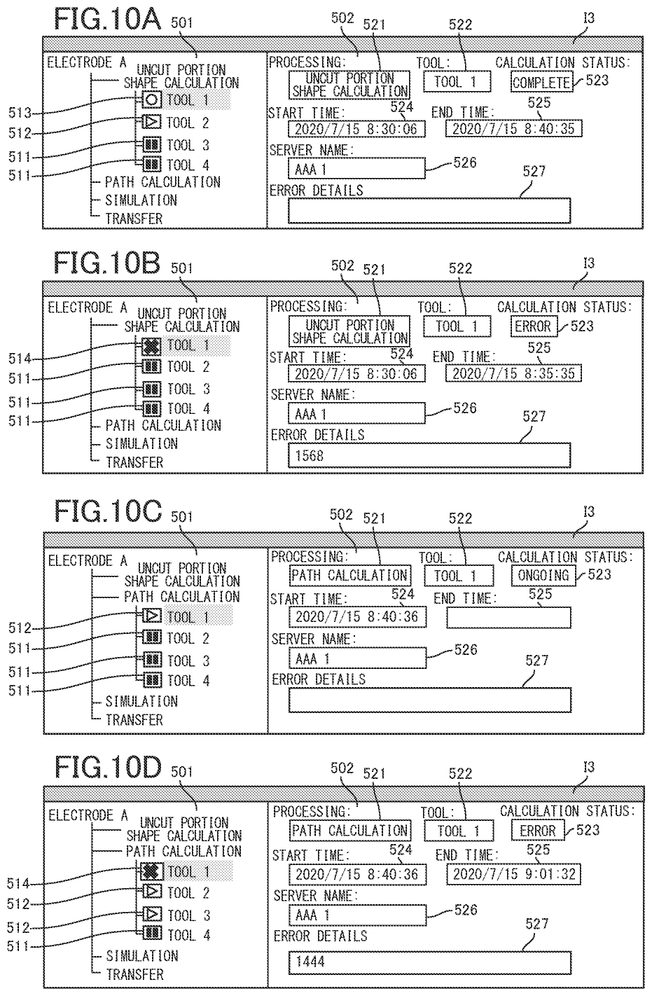

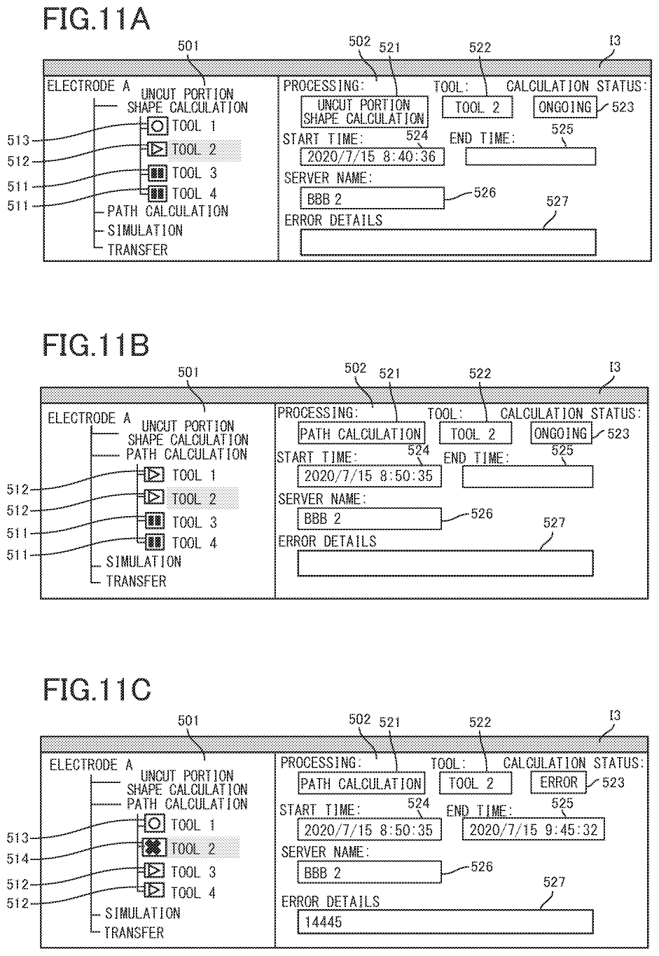

Here, after the instruction portion 7 has sent an instruction to perform the jobs J1 to J4 in step S110, the display controller 6 of the information processing apparatus 300 displays the status of processing of each of the jobs J1 to J4 on the display device 302 as an interface image in step S111. FIGS. 10A to 10D and FIG. 11A to 11C are each an explanatory diagram of an example of an interface image 13 according to the embodiment. The interface image 13 illustrated in FIGS. 10A to 10D and 11A to 11C is displayed on the display device 302 after the instruction of the jobs J1 to J4. Further, in the interface image 13 illustrated in FIGS. 10A to 10D and FIGS. 11A to 11C, the status of processing for the job J1 among the plurality of jobs J1 to J4 is displayed. The display controller 6 displays the interface image 13 on the display device 302 in accordance with the status of processing of the job J1 as illustrated in FIGS. 10A to 10D and FIGS. 11A to 11C. That is, the interface image 13 changes in accordance with the processing status of the servers 3, and therefore is illustrated in FIGS. 10A to 10D and FIGS. 11A to 11C as an example.

The servers 3 transmit data indicating the processing status to the information processing apparatus 300 at a predetermined time interval. The display controller 6 updates the interface image 13 on the basis of the data indicating the processing status received from the servers 3. Therefore, the processing status of the servers 3 is displayed in the interface image 13 in almost real time, and therefore the user can recognize the processing status of the servers 3 in almost real time. The processing status includes the calculation status and error status in the path calculation module 11 of each server 3, the calculation status and error status in the simulation module 12, and the like. In the information processing apparatus 300, various statuses that have been received are displayed in the interface image 13.

To be noted, examples of errors that occur in the path calculation module 11 of the servers 3 include a failure in difference set operation and lack of model surface contained in the input data. In addition, examples of errors that occur in the simulation module 12 of the servers 3 include interference of the shank, holder, or main shaft of the tool model with the workpiece model. In addition, examples of errors that occur in the simulation module 12 of the servers 3 include an insufficient cutting error and an excessive cutting error. The insufficient cutting error and the excessive cutting error correspond to cases where a difference in a predetermined direction between a model surface, which is obtained by subtracting a portion where the tool model has been moved in a scanning manner in accordance with the path information with respect to the workpiece model from the workpiece model, and the model surface of the product is equal to or more than a threshold value.

The interface image 13 contains a tree display area 501, and a detail display area 502 that displays detailed information of the processing status corresponding to a node selected in the tree display area 501. When “Electrode A”, which is a parent node, is selected by the user in the tree display area 501, the display controller 6 unfolds and displays “Uncut portion shape calculation”, “Path calculation”, “Simulation”, “Transfer”, and the like that are child nodes branching out from “Electrode A”.

When “Uncut portion shape calculation” is selected by the user, the display controller 6 displays “Tool 1”, “Tool 2”, “Tool 3”, and “Tool 4”, which are grandchild nodes branching out from “Uncut portion shape calculation”, and displays an image indicating the status of corresponding processing. In the displayed screen, “Tool 1” represents the first tool that is used first, “Tool 2” represents the second tool that is used after the first tool, “Tool 3” represents the third tool that is used after the second tool, and “Tool 4” represents the fourth tool that is used after the third tool. A plurality of tools used for machining of one product will be regarded as a series of tools. The plurality of tools (series of tools) corresponds to a first plurality of tools. For each of “Tool 1”, “Tool 2”, “Tool 3”, and “Tool 4” branching out from “Uncut portion shape calculation”, the calculation status of the uncut portion shape by the corresponding tool in the server 3 is indicated by one of icon images 511 to 514. When “Path calculation” is selected by the user, the display controller 6 displays “Tool 1”, “Tool 2”, “Tool 3”, and “Tool 4”, which are grandchild nodes branching out from “Path calculation”, and displays an image indicating the status of corresponding processing. For each of “Tool 1”, “Tool 2”, “Tool 3”, and “Tool 4” branching out from “Path calculation”, the calculation status of the path for the corresponding tool in the server 3 is indicated by one of the icon images 511 to 514. Here, the icon image 511 containing two vertical bars indicates “not calculated”, the icon image 512 containing a triangle indicates “being calculated”, the icon image 513 containing a circle indicates “calculation completed”, and the icon image 514 containing an x mark indicates an error. By displaying the processing status of the servers 3 hierarchically in the form of a tree in the tree display area 501, the user can easily grasp the processing status of the jobs instructed to the servers 3. For example, in the interface image 13 illustrated in FIG. 10D, it can be easily seen from two icon images 512 that the path calculation for the second tool (step S214 in FIG. 7B) and the path calculation for the third tool (step S216 in FIG. 7B) are performed in parallel. For example, in the interface image 13 illustrated in FIG. 11B, it can be easily seen from two icon images 512 that the path calculation for the first tool (step S212 in FIG. 7B) and the path calculation for the second tool (step S214 in FIG. 7B) are performed in parallel. To be noted, even if the icon images 511 to 514 are not displayed in the tree display area 501, the fact that path calculation for a plurality of tools is performed in parallel can be recognized by checking the calculation status of the processing of each tool in the detail display area 502 of the tool. However, it is easier to grasp the status of processing of a plurality of tools by displaying the status by a plurality of icon images in the interface image 13.

When any one of “Tool 1”, “Tool 2”, “Tool 3”, and “Tool 4” is selected by the user in the tree display area 501, the display controller 6 displays corresponding detailed information in the detail display area 502. The detail display area 502 displays a plurality of boxes 521 to 527. The boxes 521 to 527 each display detailed information as an image that is easily recognizable by the user, for example, a character string image. In the box 521, a character string image indicating the processing is displayed such that whether the uncut portion shape is being calculated or the path is being calculated can be easily understood. In the box 522, a character string image assigned to a tool is displayed such that which of the plurality of tools the processing corresponds to can be understood. In the box 523, a character string image indicating the status of corresponding calculation in the server 3 is displayed. In the box 524, an image indicating the start time of the corresponding calculation is displayed, and in the box 525, an image indicating the end time of the corresponding calculation is displayed. In the box 526, the name of the server 3 that is performing or has performed the corresponding calculation is displayed as a character string image. In the box 526, an image corresponding to an error, for example, an error code image is displayed in the case where an error has occurred in the corresponding calculation.

In the case where “Tool 1” branching out from “Uncut portion shape calculation” has been selected by the user, the display controller 6 displays the status of step S211 of FIG. 7B in the servers 3 in the detail display area 502 as illustrated in FIGS. 10A and 10B. In the case where the calculation of the uncut portion shape has not been finished normally in step S211, the path calculation module 11 of the server 3 notifies the information processing apparatus 300 of error information. When an error has occurred in step S211, the display controller 6 displays, as images corresponding to the error, the icon image 514 in the tree display area 501, and an error code in the box 527 of the detail display area 502 as illustrated in FIG. 10B. As a result of this, in the case where an error has occurred in the calculation process of the uncut portion shape serving as a machined shape, the user can recognize the error by looking at the interface image 13 before the path calculation for the tool. As described above, the error can be recognized in an early stage, therefore correction operation of the input data D11 thereafter can be quickly performed, and thus the lead time can be shortened.

In addition, in the case where “Tool 1” branching out from “Path calculation” has been selected by the user, the display controller 6 displays the status of step S212 of FIG. 7B in the server 3 in the detail display area 502 as illustrated in FIGS. 10C and 10D. In the case where the calculation of the path has not been finished normally in step S212, the path calculation module 11 of the server 3 notifies the information processing apparatus 300 of error information. When an error has occurred in step S212, the display controller 6 displays, as images corresponding to the error, the icon image 514 in the tree display area 501, and an error code in the box 527 of the detail display area 502 as illustrated in FIG. 10D. As a result of this, in the case where an error has occurred in the calculation process of the path calculation for the tool, the user can recognize the error by looking at the interface image 13. As described above, the error can be recognized in an early stage, therefore correction operation of the input data D11 thereafter can be quickly performed, and thus the lead time can be shortened.

Similarly, in the case where “Tool 2” branching out from “Uncut portion shape calculation” has been selected by the user, the display controller 6 displays the status of step S213 of FIG. 7B in the server 3 in the detail display area 502 as illustrated in FIG. 11A.

Similarly, in the case where “Tool 2” branching out from “Path calculation” has been selected by the user, the display controller 6 displays the status of step S214 of FIG. 7B in the server 3 in the detail display area 502 as illustrated in FIGS. 11B and 11C. In the case where the calculation of the path has not been finished normally in step S214, the path calculation module 11 of the server 3 notifies the information processing apparatus 300 of error information. When an error has occurred in step S214, the display controller 6 displays, as images corresponding to the error, the icon image 514 in the tree display area 501, and an error code in the box 527 of the detail display area 502 as illustrated in FIG. 11C. As a result of this, in the case where an error has occurred in the calculation process of the path calculation for the tool, the user can recognize the error by looking at the interface image 13. As described above, the error can be recognized in an early stage in the case of parallel processing, therefore correction operation of the input data D12 thereafter can be quickly performed, and thus the lead time can be shortened.

Therefore, the user can take measure such as instructing the server 3 to stop the processing, correcting the input data, or notifying an administrator of the server 3 in accordance with the content of processing and the content of error. Further, since the user can recognize the processing status, an error can be dealt with quickly. Since the processing status is displayed as the icon images 511 to 514 in the tree display area 501, the user can recognize a plurality of processing statuses, and thus a quick responsive action can be taken. In addition. the display controller 6 displays a server name in the box 526 as information indicating the server. In the case of the user sending a notification to the administrator of the server 3, a more appropriate responsive action can be taken by notifying the server name together with the error code.

In addition, for example, by informing the administrator of the server 3 of the content of the error displayed in the interface image 13, the administrator can quickly correct the error. As a result of this, the time from the occurrence of the error to the correction of the error can be shortened, and increase in the lead time can be avoided.

In addition, in accordance with the error code, the user can update the version of the program 350 installed in the information processing apparatus 300. In addition, in accordance with the error code, the user can change the allowable value of logical computation used in the path calculation module 11 of the server 3, and cause the path calculation module 11 to perform re-calculation.

In addition, since the status of the processing in which step S212 and S214 are executed in parallel in the servers 3 is also displayed in the interface image 13, the user can recognize the status of steps S212 and S214 in the interface image 13.

After the path calculation for the four tools corresponding to the electrode A is executed, the servers 3 store the information (data) of the paths for the four tools as the NC data D21 in the storage apparatus 916. Then, in step S124, the server 3 simulates cutting on the basis of the information of path for each of the four tools contained in the NC data D21. The processing of this step S124 serves as fifth information processing. That is, the simulation module 12 conducts a simulation test of machining in accordance with the NC data D21 generated by the path calculation module 11. As a result of this simulation of cutting, checking the interference can be automated, and thus the operation can be made more efficient.

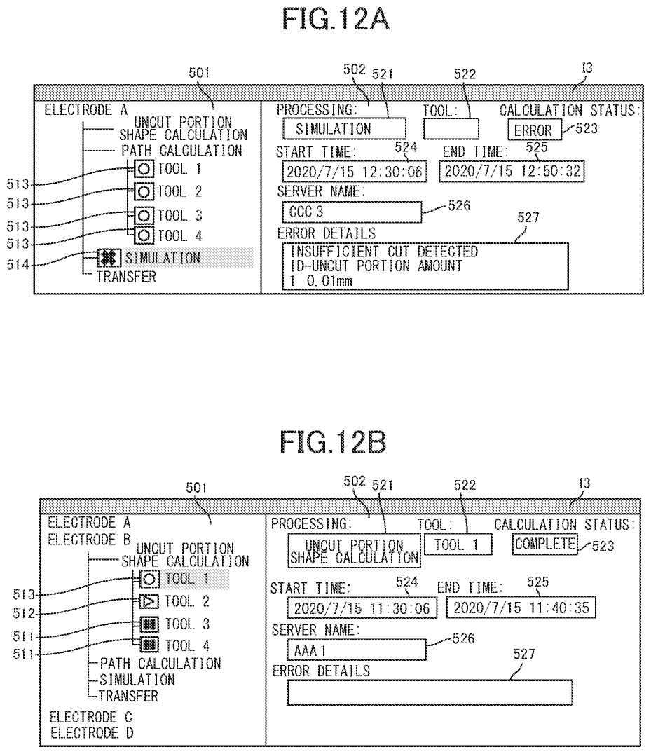

Meanwhile, in step S111, the display controller 6 of the information processing apparatus 300 displays the status of step S124 of the server 3 in the interface image 13. FIG. 12A is an explanatory diagram of an example of the interface image 13 according to the embodiment.

In the case where “Simulation” has been selected by the user in the tree display area 501, the display controller 6 displays the status of simulation processing of step S124 in the server 3 in the detail display area 502 as illustrated in FIG. 12A. When an error has occurred in the processing of step S124 the display controller 6 displays, as images corresponding to the error, the icon image 514 in the tree display area 501, and the content of the error in the box 527 of the detail display area 502 as illustrated in FIG. 12A.

In step S125, the server 3 transmits the NC data D21 to the information processing apparatus 300 after the simulation processing.

On the other hand, while the interface image 13 is displayed on the display device 302 in step S111 in the information processing apparatus 300, the processing in the servers 3 is sometimes stopped by an instruction from the user or by an error.

In step S112, the display controller 6 determines whether or not the server 3 has stopped the processing, and in the case where the processing is stopped, that is, in the case where the result of step S112 is YES, the processing is finished. As a result of this, the user can change the corresponding electrode model among the electrode models 141 to 144 in accordance with the error, or notify the administrator of the server 3 of the occurrence of error. Therefore, the user can deal with the error quickly. To be noted, the stoppage of the processing may be performed for each of the jobs J1 to J4, or for each of the tools in each of the jobs J1 to J4.

In the case where the processing is not stopped, that is, in the case where the result of step S112 is NO, the display controller 6 stands by for the NC data D21 in step S113, and in the case where the NC data D21 is not received, that is, in the case where the result of step S113 is NO, returns to step S112.

In the case where the display controller 6 has received the NC data D21, that is, in the case where the result of step S113 is YES, and in the case where no error has occurred in the path calculation or the simulation, that is, in the case where the result of step S114 is NO, the transfer portion 13 automatically transfers the NC data D21 to the storage device 14 or the machining apparatus 17 in step S115. Here, examples of data transfer include copying and moving the data.

In the case where an error has occurred in the path calculation or the simulation, that is, in the case where the result of step S114 is YES, the transfer portion 13 stands by for an instruction from the user on whether to transfer the data in step S116. As a result of this, the user can determine whether or not there is a problem in the received NC data 21. In the case where the user has determined that there is no problem, the user can input to the information processing apparatus 300 an instruction to transfer the NC data D21, and in the case where the user has determined that there is a problem, the user can input to the information processing apparatus 300 an instruction to not transfer the NC data D21. In the case where the transfer portion 13 has received an instruction to transfer the data, that is, in the case where the result of step S116 is YES, the transfer portion 13 transfers the NC data D21 to the storage device 14 or the machining apparatus 17 in step S115. In the case where the transfer portion 13 has received an instruction to not transfer the data, that is, in the case where the result of step S116 is NO, the transfer portion 13 finishes the processing without transferring the NC data D21.

A case were the server 3 executes the job J1 has been described above as an example. In the present embodiment, since the servers 3 have received the plurality of jobs J1 to J4, the servers 3 execute the plurality of jobs J1 to J4 in this order.

FIG. 12B is an explanatory diagram of an example of the interface image 13 according to the embodiment. The display controller 6 displays, in accordance with an operation from the user, the status of the processing of the job J2 corresponding to the electrode B in the tree display area 501 and the detail display area 502 of the interface image 13 as illustrated in FIG. 12B. “Tool 1” to “Tool 4” illustrated in FIG. 12B are a plurality of tools (series of tools) used for machining of the electrode B, and correspond to a second plurality of tools.

To be noted, the servers 3 can process the jobs J1 to J4 in parallel depending on the number and processing performance of the servers 3. In this manner, the servers 3 obtain the NC data D21 to D24 in step S123, and perform simulation of the cutting based on each of the NC data D21 to D24 in step S124. Then, the servers 3 sequentially transmit the NC data D21 to D24 in step S125, and thus the information processing apparatus 300 sequentially receives the NC data D21 to D24 from the servers 3, that is, the result of step S113 is YES.

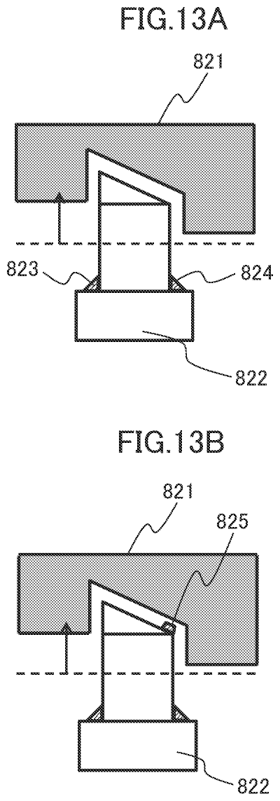

Here, in step S124, although a case where simulation of cutting by a plurality of tools (tool models) is performed has been described, simulation of electric discharge machining may be performed by using electrode models generated by the simulation of the cuffing. FIGS. 13A and 13B are each a schematic diagram illustrating a result of simulation of electric discharge machining according to the embodiment. Depending on the shape and location of the uncut portion in the electrode, there is a case where a problem arises in electric discharge machining and a case where a problem does not arise. FIG. 13A illustrates a mold model 821 formed by the electric discharge machining simulation, and an electrode model 822. As illustrated in FIG. 13A, in the case where uncut portions 823 and 824 are present at the root of the shaft of the electrode model 822, the shape of the mold model 821 to be formed is hardly affected. However, in FIG. 13B, an uncut portion 825 is present at a tip end portion of the shaft of the electrode model 822, that is, at a part where electric discharge machining is performed, the uncut portion 825 is close to a surface of the mold model 821, there is a possibility that the shape of the mold model 821 to be formed is affected. Also in such a case, an error can be displayed in the interface image 13, and thus the user can recognize the error.

As described above, according to the present embodiment, the user can issue instructions of the input data D11 to D14 corresponding to the plurality of electrodes at once. In addition, also in the servers 3, the path calculation can be performed in parallel for each of the input data D11 to D14. In addition, the user can check the calculation in the servers 3 in almost real time in the interface image 13. As a result of this, the operation time of the user and the calculation time of the servers 3 can be shortened, and thus the lead time can be shortened.

To be noted, although a case where path calculation and simulation are performed by distributed processing among the plurality of servers 3 has been described in the above embodiment, the configuration is not limited to this. Even if only one server 3 is provided, the present invention can be applied if the server 3 is capable of multitasking.

In addition, although a case where the information processing apparatus 300 instructs jobs to the servers 3 and causes the servers 3 to perform the path calculation for the tools and the simulation has been described in the above embodiment, the configuration is not limited to this. For example, the information processing apparatus 300 may have a path calculation function and a simulation function in addition to the function of the program 350. Alternatively, for example, the information processing apparatus 300 may have a simulation function in addition to the function of the program 350, and may perform the simulation by using NC data received from the servers 3.

In addition, although a case where machining such as cutting is simulated has been described in the above embodiment, the present invention can be also applied to a case where the simulation is omitted.

In addition, although a case of a plurality of electrodes has been described in the above embodiment, the configuration is not limited to this. The present invention can be also applied to a case of a single electrode.

In addition, although a case where the product is an electrode has been described as an example in the above embodiment, the configuration is not limited to this, and the present invention can be applied to any product.

In addition, although a case where the information processing apparatus 300 transmits NC data to the storage device 14 or the machining apparatus 17 via a network such as a LAN has been described in the above embodiment, the configuration is not limited to this. For example, the NC data may be copied or moved to an unillustrated storage such as a universal serial bus: USB memory from the information processing apparatus 300, and the NC data stored in the storage may be supplied to the machining apparatus 17.

The embodiment described above can be appropriately modified within the technical concept. In addition, part of the matter of the embodiment can be removed or replaced. In addition, new matter can be added to the embodiment. For the description of the embodiment, a first tool is exemplified as the first tool 201 (tool 1), and a second tool is exemplified as the second tool 202 (tool 2). However, the first tool may be any tool among the series of tools except for the last tool, and the second tool may be any tool except for the tool that is used first among the series of tools as long as the second tool is used after (usually immediately after) the first tool. Further, the first information processing may be processing for calculating the uncut portion shape formed by the first tool, and the second information processing may be processing for calculating the path for the first tool. Therefore, the first information processing and the second information processing are not limited to processing for the first tool 201, and can be processing related to the second tool 202 or the third tool (tool 3). Similarly, the third information processing may be processing for calculating the path for the second tool, and the fourth information processing may be processing for calculating the uncut portion shape formed by the second tool. Therefore, the third information processing and the fourth information processing are not limited to processing for the second tool 202, and can be processing related to the third tool 203 (tool 3) or the fourth tool (tool 4).

To be noted the disclosure of the present specification is not limited to what is explicitly described in the present specification, and include all the matter that can be grasped from the present specification and drawings attached to the present specification. In addition, the disclosure of the present specification includes a complementary set of individual concepts described in the present specification. That is, for example, if description of “A is B” is included in the present specification, the present specification discloses a case where “A is not B” even if description of “A is not B” is omitted. This is because a case where “A is B” is described on the basis of the fact that a case where “A is not B” is considered.

As described above, according to the present disclosure, a technique advantageous for shortening the lead time can be provided.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-101666, filed Jun. 18, 2021, which is hereby incorporated by reference herein in its entirety.

What is claimed is:

1. An information processing method comprising:
preparing first data containing information of a workpiece, information of a product, and information of a plurality of tools used for machining the workpiece to manufacture the product;
instructing a job to generate second data by using the first data, the second data containing information of respective paths for the plurality of tools; and
displaying a status of information processing of the job on a display portion after the instructing of the job,
wherein the displaying includes displaying, on the display portion, a status of first information processing of calculating a machined shape formed by a first tool included in the plurality of tools and a status of second information processing of calculating a path for the first tool that is performed after the first information processing.

2. The information processing method according to claim 1, wherein the displaying includes displaying, when an error has occurred in the first information processing, a corresponding image on the display portion.

3. The information processing method according to claim 1, wherein the displaying includes displaying, when an error has occurred in the second information processing, a corresponding image on the display portion.

4. The information processing method according to claim 1, wherein the displaying includes displaying, on the display portion, a status of third information processing of calculating a path for a second tool that is used after machining by the first tool.

5. The information processing method according to claim 4, wherein the second information processing and the third information processing are performed in parallel.

6. The information processing method according to claim 4, wherein the displaying includes displaying, on the display portion, a status of fourth information processing of calculating a machined shape formed by the second tool, the fourth information processing being performed between an end timing of the first information processing and a start timing of the third information processing.

7. The information processing method according to claim 1, wherein the displaying includes displaying, on the display portion, a status of fifth information processing of simulating machining on a basis of information of the respective paths for the plurality of tools contained in the second data.

8. The information processing method according to claim 7, wherein the displaying includes displaying, when an error has occurred in the fifth information processing, a corresponding image on the display portion.

9. The information processing method according to claim 7, further comprising transferring the second data after the fifth information processing.

10. The information processing method according to claim 1, wherein the preparing includes automatically setting the information of the plurality of tools on a basis of the information of the product.

11. The information processing method according to claim 1, wherein the first data contains information indicating a use order of the plurality of tools.

12. The information processing method according to claim 1, wherein the first data contains information of respective machining types of the plurality of tools.

13. The information processing method according to claim 1,
wherein the workpiece is a first workpiece, the product is a first product, the plurality of tools are a first plurality of tools, and the job is a first job,
wherein the preparing includes preparing third data containing information of a second workpiece, information of a second product, and information of a second plurality of tools used for manufacturing the second product by machining the second workpiece,
wherein the instructing includes instructing a second job to generate fourth data by using the third data, the fourth data containing information of respective paths for the second plurality of tools, and
wherein the displaying includes displaying a status of information processing of the second job on the display portion.

14. The information processing method according to claim 13, wherein the preparing includes displaying, on the display portion, a table containing information related to the first plurality of tools and the second plurality of tools.

15. The information processing method according to claim 13,
wherein the preparing includes:
displaying, on the display portion, an interface image containing an image corresponding to the information of the first product and an image corresponding to the information of the second product; and
preparing the information of the first product and the information of the second product by loading the information of the first product and the information of the second product that have operated in the interface image.

16. The information processing method according to claim 13,
wherein the first product and the second product are respectively a first electrode and a second electrode that are used for perform electric discharge machining on a metal material and processing the metal workpiece into a mold, and
wherein the preparing includes displaying an image of the first electrode, an image of the second electrode, and an image of the mold on the display portion.

17. A non-transitory processor-readable recording medium storing a program for causing a processor to execute the information processing method according to claim 1.

18. An information processing apparatus comprising a processor configured to execute the program stored on the recording medium according to claim 17.

19. The information processing apparatus according to claim 18, further comprising a communication module configured to communicate with a server configured to perform the first information processing and the second information processing.

20. The information processing apparatus according to claim 19, wherein the processor displays, on the display portion, a status of the first information processing and a status of the second information processing in the server.

21. An information processing apparatus comprising a processor,
wherein the processor is configured to execute
processing to prepare first data containing information of a workpiece, information of a product, and information of a plurality of tools used for machining the workpiece to manufacture the product,
processing to instruct a job to generate second data by using the first data, the second data containing information of respective paths for the plurality of tools, and
processing to display a status of information processing of the job on a display portion after the instructing of the job, and
wherein the processing to display includes displaying, on the display portion, a status of first information processing of calculating a machined shape formed by a first tool included in the plurality of tools and a status of second information processing of calculating a path for the first tool that is performed after the first information processing.

22. An information processing method comprising:
obtaining first data containing information of a workpiece, information of a product, and information of a plurality of tools used for manufacturing the product by machining the workpiece; and
generating second data by using the first data, the second data containing information of respective paths for the plurality of tools,
wherein the generating the second data includes performing first information processing of calculating a machined shape formed by a first tool included in the plurality of tools and second information processing of calculating a path for the first tool that is performed after the first information processing.

23. The information processing method according to claim 22, wherein the generating the second data includes performing third information processing of calculating a path for a second tool of the plurality of tools that is used after machining by the first tool.

24. The information processing method according to claim 23, wherein in the third information processing, the path for the second tool is calculated on a basis of the machined shape formed by the first tool calculated in the first information processing.

25. The information processing method according to claim 23, wherein the second information processing and the third information processing are performed in parallel.

26. The information processing method according to claim 22, comprising simulating machining on a basis of information of the respective paths for the plurality of tools that is contained in the second data.
